(19) United States
(12) Patent Application Publication
(10) Pub. No.: US 2026/0172871 A1
(43) Pub. Date: Jun. 18, 2026

(54) CARRIER SPECIFIC SCALING FACTOR (CSSF) DETERMINATION FOR WIRELESS SYSTEMS WITH DUAL CONNECTIVITY

(71) Applicant: Apple Inc., Cupertino, CA (US)

(72) Inventors: Jie CUI, San Jose, CA (US); Yang TANG, San Jose, CA (US); Qiming LI, Beijing (CN); Manasa RAGHAVAN, Sunnyvale, CA (US); Xiang CHEN, Campbell, CA (US); Dawei ZHANG, Saratoga, CA (US); Hong HE, San Jose, CA (US); Yuexia SONG, Beijing (CN); Rolando E. Bettancourt ORTEGA, Munich (DE); Haitong SUN, Cupertino, CA (US)

(73) Assignee: Apple Inc., Cupertino, CA (US)

(21) Appl. No.: 19/126,964

(22) PCT Filed: Nov. 4, 2022
(86) PCT No.: PCT/CN2022/130013

§ 371 Date: May 2, 2025

(51) Int. Cl. H04W 24/10

(52) U.S. Cl. CPC H04W 24/10

(57) ABSTRACT

Some aspects relate to apparatuses and methods for a wireless system supporting dual connectivity for a user equipment (UE) with a plurality of base stations in a plurality of cells over a plurality of component carriers including a first base station in a primary cell by a primary component carrier in a first frequency band and a second base station in a secondary cell by a secondary component carrier in a second frequency band. The UE can determine a measurement gap sharing scheme based at least on whether a plurality of measurement objects (MOs) includes any MO different from an intra-frequency MO, where the measurement gap sharing scheme indicates how to share the plurality of measurement gaps to perform measurements on the plurality of MOs. The UE can further determine a carrier specific scaling factor for a MO based on the measurement gap sharing scheme.

### BACKGROUND

### Field

The described aspects generally relate to wireless communication, including carrier specific scaling factor (CSSF) determination for wireless systems with dual connectivity.

### Related Art

In a wireless system, dual connectivity (DC) has been used to increase data throughput at a user equipment (UE). In a wireless system with DC, the UE can transmit and receive data on multiple component carriers from two cell groups to increase the throughput of the UE. In the fifth generation (5G) new radio (NR) standard developed by the 3rd Generation Partnership Project (3GPP), dual connectivity to a UE can be provided by a first base station serving in a primary cell (PCell) and a second base station serving in a secondary cell (SCell). New Radio Dual Connectivity (NR DC) allows a UE to be connected to two serving nodes having multiple carriers in each node using the carrier aggregation technique. However, it is desired to improve the operational efficiency for a UE with dual connectivity.

### SUMMARY

Some aspects of this disclosure relate to apparatuses and methods for implementing mechanisms to determine how to share a plurality of measurement gaps by a plurality of measurement objects (MO) to support dual connectivity (DC) for a user equipment (UE). Embodiments herein can be applicable to the fifth generation (5G) new radio (NR) wireless networks or systems developed based on the 3rd Generation Partnership Project (3GPP) standards. In some other embodiments, techniques presented herein can be applicable to other DC between multiple radio access technology (RAT) for a multi-mode user equipment (UE), where the multiple RAT may include a NR RAT. In some embodiments, the 5G NR system can be deployed using non-standalone (NSA) option or standalone (SA) option.

Some aspects of this disclosure relate to a UE. The UE can include a transceiver, and a processor communicatively coupled to the transceiver. The transceiver can be configured to communicate in a wireless system supporting dual connectivity having a plurality of base stations in a plurality of cells utilizing a plurality of component carriers. In some embodiments, the UE can communicate with a first base station in a primary cell (PCell) utilizing a primary component carrier (PCC) in a first frequency band, and communicate with a second base station in a primary secondary cell (PSCell) utilizing a primary secondary component carrier (PSCC) in a second frequency band. In some embodiments, the first frequency band may be in a first frequency range (FR1), and the second frequency band can be in the first frequency range (FR1) or a second frequency range (FR2). In some embodiments, the dual connectivity supported by the wireless system can include a NR DC, and the first base station and the second base station can include a next generation NodeB (gNB). There can be other kinds of base station, RAT, component carriers for some other embodiments.

According to some aspects, the processor of the UE can determine how to share a plurality of measurement gaps by a plurality of measurement objects (MO) to support dual connectivity (DC). The processor of the UE can be configured to receive a measurement object configuration to configure the plurality of MOs corresponding to the plurality of cells over the plurality of component carriers including the PCC and SCC, and determine a measurement gap configuration to configure the plurality of measurement gaps shared by the plurality of MOs. In some embodiments, a MO can include a synchronization signal block (SSB), or a channel state information reference signal (CSI-RS).

According to some aspects, based on whether the plurality of MOs includes any MO different from an intra-frequency MO, the UE can determine a measurement gap sharing scheme indicating how to share the plurality of measurement gaps to perform measurements on the plurality of MOs. Afterwards, the UE can determine a carrier specific scaling factor (CSSF) for a MO of the plurality of MOs based on the measurement gap sharing scheme. Based on the CSSF for the MO, the UE can determine a measurement period corresponding to the MO to perform measurement on the MO within the plurality of measurement gaps.

In some embodiments, in response to a determination that the plurality of MOs includes only intra-frequency MOs, the UE can apply a first measurement gap sharing scheme. In addition, in response to a determination that the plurality of MOs includes a MO that is not an intra-frequency MO, the UE can apply a second measurement gap sharing scheme different from the first measurement gap sharing scheme.

According to some aspects, the processor of the UE can be configured to determine that the plurality of MOs includes only intra-frequency MOs, and the measurement gap sharing scheme indicates to share the plurality of measurement gaps equally among a plurality of MOs over a plurality of serving cells including the PCell. Accordingly, the CSSF for the MO of the plurality of MOs over the plurality of serving cells can be determined based on a total number of measurement objects over the plurality of serving cells for the plurality of measurement gaps.

According to some aspects, the processor of the UE can be configured to determine that the plurality of MOs includes at least a MO that is not an intra-frequency MO, and there is a first sharing parameter indicating to share the plurality of measurement gaps equally. Accordingly, the CSSF for the MO of the plurality of MOs over the plurality of serving cells can be determined based on a total number of frequency layers having a measurement gap.

According to some aspects, the processor of the UE can be configured to determine that a first sharing parameter indicates to share the plurality of measurement gaps not equally, and the measurement gap sharing scheme can be determined based on a second sharing parameter.

In some embodiments, the second sharing parameter can include a parameter indicating how to share the plurality of measurement gaps among MOs in a master cell group and a secondary cell group. In some embodiments, the second sharing parameter can include a parameter indicating how to share the plurality of measurement gaps among MOs for a special component carrier (SPCC) or a secondary component carrier (SCC). In some embodiments, the second sharing parameter can include a parameter indicating how to share the plurality of measurement gaps among MOs for a first frequency range or a second frequency range. In some embodiments, the second sharing parameter can include a parameter indicating how to share the plurality of measurement gaps among MOs for intra-frequency MOs unequally.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates a wireless system to support sharing a plurality of measurement gaps by a plurality of measurement objects (MO) to support dual connectivity (DC) for a user equipment (UE), according to some aspects of the disclosure.

FIG. 2 illustrates a block diagram of a UE to perform functions described herein, according to some aspects of the disclosure.

FIG. 3 illustrates an example process performed by a UE to support sharing a plurality of measurement gaps by a plurality of MOs to support DC for a UE, according to some aspects of the disclosure.

FIG. 4 illustrates a process for determining a measurement gap sharing scheme performed by a UE to support DC for the UE, according to some aspects of the disclosure.

FIG. 5 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

In a wireless system supporting dual connectivity (DC), a user equipment (UE) can transmit and receive data on multiple component carriers (CC) from two cell groups, primary cell (PCell) group (MCG) and secondary cell (SCell) group (SCG), to increase the throughput of the UE. In some embodiments, dual connectivity can be used to aggregate long-term evolution (LTE) and 5G new radio (NR) in E-UTRA-NR (EN-DC) technology. In 5G NR DC, more than one base stations, such as g-NodeB (gNB) of the 5G wireless network, may configure a PCell using PCell CC (PCC) and one or more CCs of SCell (SCC) for communication between the UE and the 5G wireless network using dual connectivity.

In a wireless system, a UE may measure the signals, such as serving cell signals, neighboring cells signals and other carrier components to provide information about the channel conditions and interferences. In some embodiments, a UE may have to suspended communication with the serving cell for a predetermined or specific duration, and tune radio frequency (RF) module to configured frequencies including configured measurement objects (MOs) to measure the signals. These MOs may include synchronization signal block (SSBs), channel state information reference signals (CSI-RS), etc. The UE may resume connection with the serving cell after the duration being used to perform measurements on the measurement objects. The time duration during which the UE suspends its communication with the serving cell to perform measurements on the MOs can be referred to as a Measurement Gap (Meas Gap), which can also be referred to as a gap.

According to some aspects, the UE may not simultaneously perform measurements on a plurality of MOs of all configured CCs during a plurality of measurement gaps of a monitoring occasion. Instead, the MOs may share the plurality of measurement gaps to perform measurements on the plurality of MOs. The UE can further utilize a carrier specific scaling factor (CSSF) to determine measurement delay requirements and a measurement period corresponding to the MO to perform measurement on the MO within a plurality of measurement gaps. Embodiments herein present various techniques for determining a measurement gap sharing scheme based at least on whether the plurality of MOs includes any MO different from an intra-frequency MO. The measurement gap sharing scheme can indicate how to share the plurality of measurement gaps to perform measurements on the plurality of MOs.

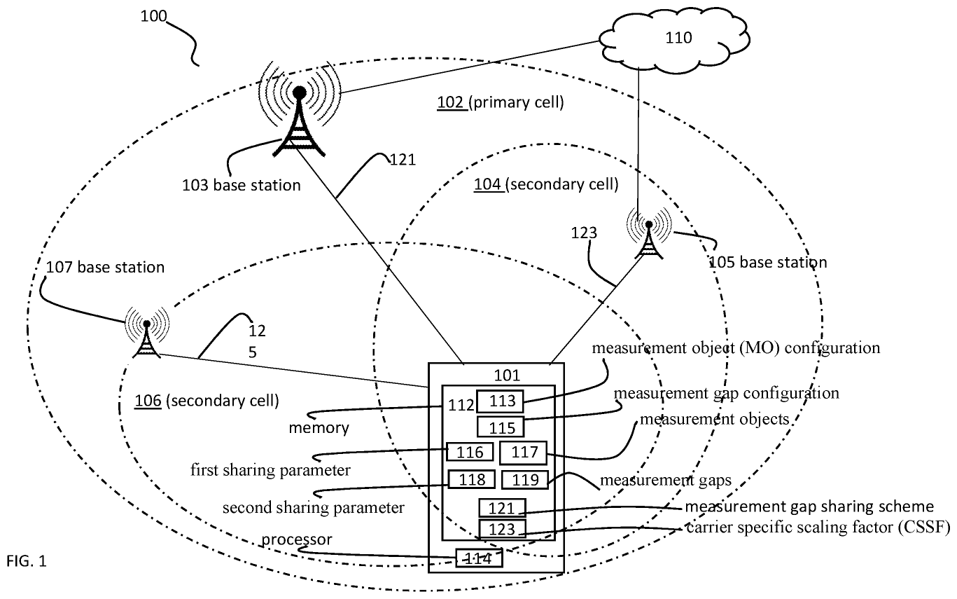

FIG. 1 illustrates a wireless system 100 including a UE, e.g., UE 101, configured to communicate with a first base station in a PCell and with a second base station in a SCell, according to some aspects of the disclosure. Wireless system 100 is provided for the purpose of illustration only and does not limit the disclosed aspects. Wireless system 100 can include, but is not limited to, UE 101, a base station 103, a base station 105, and a base station 107, all communicatively coupled to a core network 110. UE 101 communicates with base station 103 over a communication link 121, communicates with base station 105 over a communication link 123, and communicates with base station 107 over a communication link 125.

In some examples, wireless system 100 can be a NSA system that includes one or more of a NR system, a LTE system, a 5G system, or some other wireless system. In some examples, wireless system 100 can be a SA system including a NR system. There can be other network entities, e.g., network controller, a relay station, not shown. Wireless system 100 can support a wide range of use cases such as enhanced mobile broad band (eMBB), massive machine type communications (mMTC), ultra-reliable and low-latency communications (URLLC), and enhanced vehicle to anything communications (eV2X).

According to some aspects, base station 103, base station 105, and base station 107 can be a fixed station or a mobile station. Base station 103, base station 105, and base station 107 can also be called other names, such as a base transceiver system (BTS), an access point (AP), a transmission/reception point (TRP), an evolved NodeB (eNB), a next generation node B (gNB), a 5G node B (NB), or some other equivalent terminology. In some examples, base station 103 can be a gNB, while base station 105 and base station 107 can be a gNB or an eNB. In some examples, base station 103, base station 105, and base station 107 can be interconnected to one another and/or to other base station or network nodes in a network through various types of backhaul interfaces such as a direct physical connection, a virtual network, and/or the like, not shown.

According to some aspects, UE 101 can be stationary or mobile. UE 101 can be a cellular phone (e.g., a smart phone), a personal digital assistant (PDA), a wireless modem, a wireless communication device, a handheld device, a laptop, a desktop, a cordless phone, a wireless local loop station, a wireless sensor, a tablet, a camera, a video surveillance camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include, a robot, a drone, a location tag, and/or the like.

According to some aspects, base station 103, base station 105, and base station 107 can be communicatively coupled to core network 110. Base station 103 can serve a cell 102, base station 105 can serve a cell 104 contained within cell 102, and base station 107 can serve a cell 106 contained within cell 102 that overlaps with cell 104. In some other embodiments, cell 102 can overlap partially with cell 104 or cell 106. Cell 102, cell 104, and cell 106 can be a macro cell, a pico cell, a femto cell, and/or another type of cell. In comparison, a macro cell can cover a relatively large geographic area, e.g., several kilometers in radius, a femto cell can cover a relatively small geographic area, e.g., a home, while a pico cell covers an area smaller than the area covered by a macro cell but larger than the area covered by a femto cell. For example, cell 102 can be a macro cell, while cell 104 and cell 106 can be a pico cell or a femto cell. In addition, cell 102 can be a pico cell while cell 104 and cell 106 can be a femto cell. In some examples, the geographic area of a cell can move according to the location of a mobile base station.

According to some aspects, base station 103 can be the serving base station, a primary node, or a master node (MN), and cell 102 can be the serving cell or primary cell (PCell). Base station 105 and base station 107 can be neighbor base station to UE 101 that can be a secondary node (SN). Cell 104 and cell 106 can be a secondary cell (SCell), or a primary secondary cell (PScell). There can be other secondary cells for UE 101, not shown. Data for UE 101 can be simultaneously transferred between UE 101 and core network 110 by one or more component carriers between UE 101 and base station 103 at communication link 121, one or more component carriers between UE 101 and base station 105 at communication link 123, and one or more component carriers between UE 101 and base station 107 at communication link 125. UE 101 can communicate with the serving base station, e.g., base station 103, using a first frequency band, and communicate with a neighbor base station, e.g., base station 105 or base station 107 using a second frequency band different from the first frequency band. In some embodiments, cell 102, which is the PCell, may be referred to as the anchor cell that provides a radio resource control (RRC) connection to the UE 101. In some examples, the PCell (cell 102) and the SCell, e.g., cell 104, may be co-located (e.g., different TRPs at the same location).

In some embodiments, one or more of the SCells, such as cell 104 or cell 106, may be activated or added to cell 102, which is the PCell, to form the serving cells serving the UE 101. Each serving cell corresponds to one or more CCs. The CC of the PCell, e.g., cell 102, may be referred to as a primary CC (PCC), and the CC of a SCell, e.g., cell 104 or cell 106, may be referred to as a secondary CC (SCC). The PCell (cell 102) and one or more of the SCells (cell 104 or cell 106) may be served by a respective base station 103, 105, and 107. The coverages of the PCell and SCell may differ since component carriers in different frequency bands may experience different path loss. In some embodiments, the PCell (cell 102) may add or remove one or more of the SCells (cell 104 or cell 106) to improve reliability of the connection to the UE 101 and/or increase the data rate.

In some embodiments, the PCell (cell 102) may be a low band cell using a low frequency band, and the SCells (cell 104 or cell 106) may be high band cells using a high frequency band. A low band (LB) cell uses a CC in a first frequency band, such as a first frequency range (FR1) that is lower than that of the high band cells using a second frequency band. Accordingly, the first frequency band can be in the first frequency range (FR1), and the second frequency band can be in the FR1, or the second frequency range (FR2). In some embodiments, the high band cells may use millimeter wave (mmW) CC, and the low band cell may use a CC in a band (e.g., sub-6 GHz band) lower than mmW. In general, a cell using a mmW CC can provide greater bandwidth than a cell using a low band CC. In addition, when using a frequency carrier that is above 6 GHz (e.g., mmW), beamforming may be used to transmit and receive signals in some examples. For example, the FR1 can be below 7.225 GHz and the FR2 frequency range can be in the mmWave frequency above 24.250 GHz. When communicating with the 5G network, the UE may be configured with one or more bandwidth parts (BWPs) of FR1 and/or FR2 on which to communicate.

In some embodiments, UE 101 may be served by a base station 103, which can be the MN, and one or more secondary nodes, e.g., base station 105 and/or base station 107. A master cell group (MCG) is associated with the base station 103 in the PCell and one or more SCells (cell 104 and/or cell 106). A secondary cell group (SCG) may be associated with the SCells. Different examples may include a different number of SCells. The MN (base station 103) may select the first SCG or the second SCG, and further select one of the SCells to be the PSCell for the SCG.

In some embodiments, the PCell, the PSCells used for serving the UE 101 may change over time. For example, due to traffic conditions at the MN (base station 103) or some other factor, the MN (base station 103) may elect to add another PSCell for serving UE 101. As another example, due to signaling conditions between the UE 101 and one or more of the current PSCells (e.g., as determined from signal measurements made by the UE 101), the MN (base station 103) or one of the PSCells may elect to change out one or more PSCells.

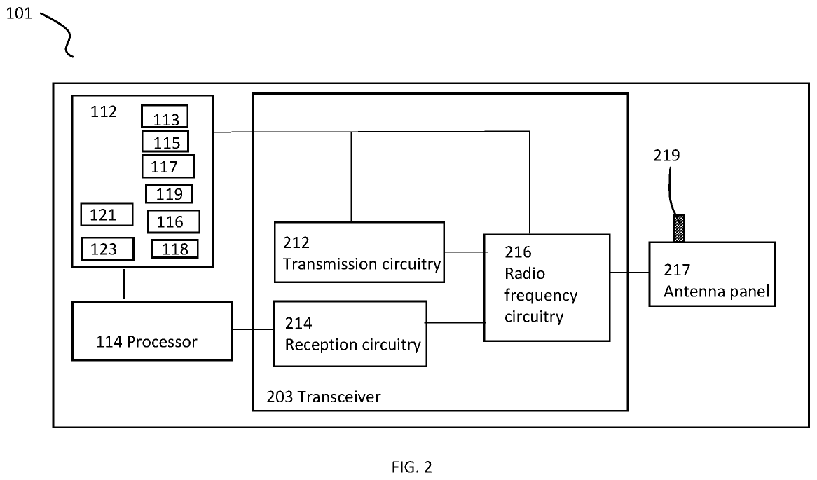

According to some aspects, UE 101 can include a memory 112, and a processor 114 communicatively coupled to the memory, and a transceiver, as shown in FIG. 2. Memory 112 can be configured to store a measurement object (MO) configuration 113, and a measurement gap configuration 115, which can be received from a base station, such as base station 103. Based on MO configuration 113, processor 114 can be configured to configure a plurality of MOs 117 corresponding to the plurality of cells over the plurality of component carriers including the PCC and SCC, and configure a plurality of measurement gaps 119 shared by the plurality of MOs 117.

In some embodiments, measurement gap configuration 115 can include a Meas Gap Lengths (MGL) and Meas Gap Repetition Period (MGRP). In some embodiments, MGL can be of value 1.5 ms, 3 ms, 3.5 ms, 4 ms, 5.5 ms, 6 ms, or some other time value; while MGRP can be of value 20 ms, 40 ms, 80 ms, 160 ms, or some other time value.

In some embodiments, processor 114 can be configured to determine a measurement gap sharing scheme 121, which indicates how to share the plurality of measurement gaps 119 to perform measurements on the plurality of MOs 117. In some embodiments, measurement gap sharing scheme 121 can be determined based at least on whether the plurality of MOs 117 includes any MO different from an intra-frequency MO. In some embodiments, processor 114 can be configured to determine a carrier specific scaling factor (CSSF) 123 for a MO of the plurality of MOs 117 based on the measurement gap sharing scheme 121; and determine, based on CSSF 123 for the MO, a measurement period corresponding to the MO to perform measurement on the MO within the plurality of measurement gaps 119.

In some embodiments, measurement gap sharing scheme 121 can be determined based a first sharing parameter 116. In some embodiments, the first sharing parameter 116 can be a parameter measGapSharingScheme. In addition, in some embodiments, measurement gap sharing scheme 121 can be determined further based a second sharing parameter 118. In some embodiments, when the first sharing parameter 116 indicates to share the plurality of measurement gaps 119 not equally or unequally, the measurement gap sharing scheme 121 can be determined based on the second sharing parameter 118. In some embodiments, the second sharing parameter 118 can include a parameter indicating how to share the plurality of measurement gaps 119 among MOs in a master cell group and a secondary cell group, defined by a parameter measGapSharingSchemeBtwCGs. In some embodiments, the second sharing parameter 118 can include a parameter indicating how to share the plurality of measurement gaps 119 among MOs for a special component carrier (SPCC) or a secondary component carrier (SCC), defined by a parameter measGapSharingSchemeBtwSpCellAndSCell. In some embodiments, the second sharing parameter 118 can include a parameter indicating how to share the plurality of measurement gaps 119 among MOs for a first frequency range or a second frequency range, defined by a parameter measGapSharingSchemeBtwFRs. In some embodiments, the second sharing parameter 118 can include a parameter indicating how to share the plurality of measurement gaps 119 among MOs for intra-frequency MOs unequally, defined by a parameter measGapSharingSchemeBtwIntra.

FIG. 2 illustrates a block diagram of UE 101, having antenna panel 217 including one or more antenna elements, e.g., an antenna element 219 coupled to transceiver 203 and controlled by processor 114. In detail, transceiver 203 can include radio frequency (RF) circuitry 216, baseband transmission circuitry 212, and baseband reception circuitry 214. RF circuitry 216 can include multiple parallel RF chains for one or more of transmit or receive functions, each connected to one or more antenna elements of the antenna panel. In addition, processor 114 can be communicatively coupled to memory 112, which is further coupled to transceiver 203.

In some examples, RF circuitry 216 is used by UE 101 to perform measurements of reference signals, and to transmit and receive data in the serving cell. Memory 112 can store measurement object (MO) configuration 113, measurement gap configuration 115, the plurality of MOs 117, the plurality of measurement gaps 119, measurement gap sharing scheme 121, CSSF 123, the first sharing parameter 116, and the second sharing parameter 118. Memory 112 can include instructions, that when executed by processor 114 perform the functions described herein. Alternatively, processor 114 can be “hard-coded” to perform the functions described herein.

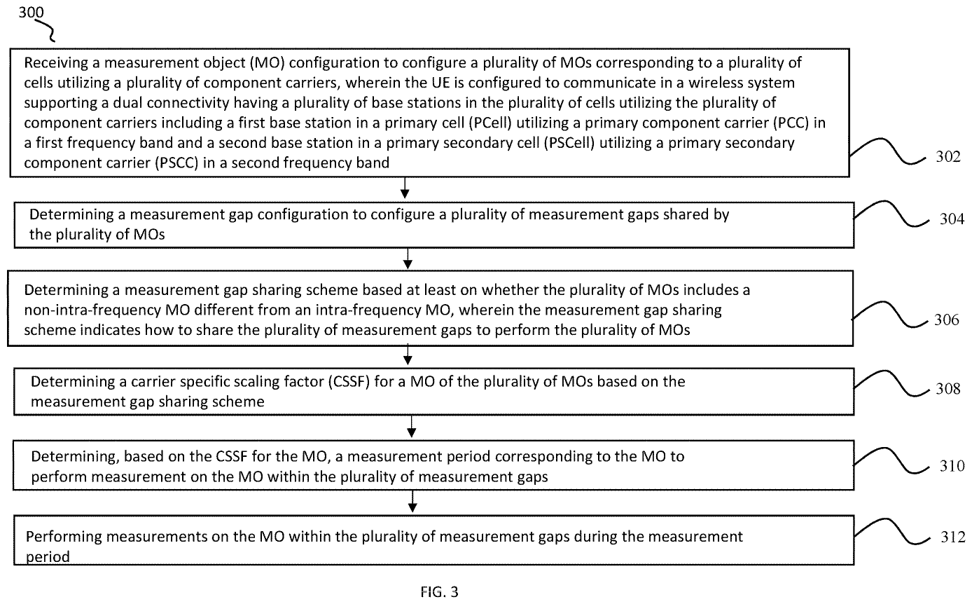

FIG. 3 illustrates an example process 300 performed by a UE to support sharing a plurality of measurement gaps by a plurality of MOs to support DC for a UE, according to some aspects of the disclosure. Process 300 can be performed by UE 101 as shown in FIGS. 1-2.

At 302, UE 101 can receive a MO configuration to configure a plurality of MOs corresponding to the plurality of cells utilizing the plurality of component carriers including the PCC and the PSCC. For example, UE 101 can receive MO configuration 113 to configure the plurality of MOs 117. The plurality of MOs 117 correspond to the plurality of cells, including PCell (cell 102), and a PSCell (cell 104, or cell 106) and a plurality of CCs including the PCC for the PCell (cell 102) and a PSCC for the PSCell (cell 104, or cell 106). In some embodiments, the PCC may be in a first frequency band within FR1, and the PSCC may be in a second frequency band, which may be within FR1 or FR2. In some embodiments, the PSCell may be any of the SCells.

At 304, UE 101 can determine a measurement gap configuration to configure a plurality of measurement gaps shared by the plurality of MOs. For example, UE 101 can determine measurement gap configuration 115 to configure the plurality of measurement gaps 119 shared by the plurality of MOs 117. A MO of the plurality of MOs 117 can include a synchronization signal block (SSB), or a channel state information reference signal (CSI-RS).

At 306, UE 101 can determine a measurement gap sharing scheme based at least on whether the plurality of MOs includes any MO different from an intra-frequency MO, where the measurement gap sharing scheme indicates how to share the plurality of measurement gaps to perform measurements on the plurality of MOs. For example, UE 101 can determine measurement gap sharing scheme 121. UE 101 can make the determination based at least on whether the plurality of MOs 117 includes any MO different from an intra-frequency MO, and the measurement gap sharing scheme 121 indicates how to share the plurality of measurement gaps 119 to perform measurements on the plurality of MOs 117. In some embodiments, any MO different from an intra-frequency MO may be an inter-frequency MO, an inter-RAT MO, or any other MO that is not for intra-frequency MO.

In some embodiments, in response to a determination that the plurality of MOs 117 include only intra-frequency MOs, UE 101 may apply a first measurement gap sharing scheme. In response to a determination that the plurality of MOs 117 includes a MO that is not an intra-frequency MO, UE 101 may apply a second measurement gap sharing scheme different from the first measurement gap sharing scheme.

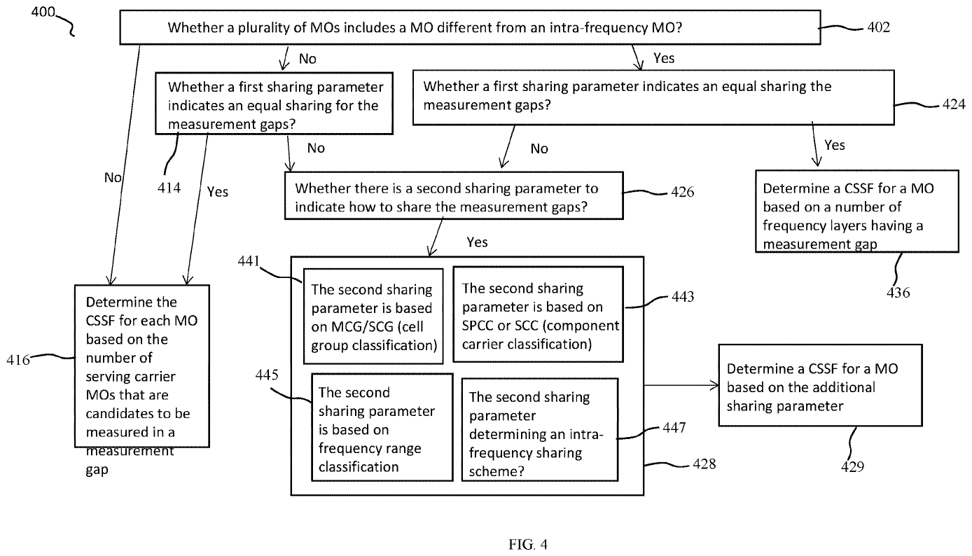

More details on how to determine measurement gap sharing scheme 121 can be illustrated in FIG. 4.

At 308, UE 101 can determine a CSSF for a MO of the plurality of MOs based on the measurement gap sharing scheme. For example, UE 101 can determine CSSF 123 for a MO of the plurality of MOs 117 based on measurement gap sharing scheme 121. For each MO of the plurality of MOs 117, there can be a corresponding CSSF 123.

In some embodiments, in response to a determination that the plurality of MOs 117 include only intra-frequency MOs, UE 101 may apply a measurement gap sharing scheme indicating to share the plurality of measurement gaps equally among a plurality of MOs over a plurality of serving cells including the PCell. Accordingly, CSSF 123 for the MO of the plurality of MOs over the plurality of serving cells can be determined based on a total number of measurement objects over the plurality of serving cells for the plurality of measurement gaps 119.

At 310, UE 101 can determine, based on the CSSF for the MO, a measurement period corresponding to the MO to perform a measurement on the MO within the plurality of measurement gaps. For example, UE 101 can determine, based on CSSF 123, a measurement period corresponding to the MO to perform a measurement on the MO within the plurality of measurement gaps 119.

At step 312, the UE performs measurements on the MO within the plurality of measurement gaps 119 during the measurement period determined based on the CSSF.

FIG. 4 illustrates a process 400 for determining a measurement gap sharing scheme performed by a UE to support DC for the UE, according to some aspects of the disclosure. Process 400 can be performed by UE 101 as shown in FIGS. 1-2, and can be applied to determine measurement gap sharing scheme 121 as described in process 300.

In some embodiments, at 402, UE 101 may determine whether the plurality of MOs 117 includes a MO different from an intra-frequency MO. If UE 101 determines there is no MO different from an intra-frequency MO, at 416, UE 101 may determine the CSSF for each MO based on the number of serving carrier MOs that are candidates to be measured in a measurement gap, without consideration of the first sharing parameter 116 or the second sharing parameter 118.

In some embodiments, if the number of configured inter-frequency and inter-RAT measurement objects and NR positioning reference signal (PRS) measurements on all positioning frequency layers is zero, the plurality of MOs 117 does not include a MO different from an intra-frequency MO. Instead, any MO of the plurality of MOs 117 is an intra-frequency MO. In some embodiments, UE 101 can be configured with per UE measurement gaps. Accordingly, UE 101 can ignore grouping rule to classify the plurality of MOs 117 and only count the parameter M_{tot,i,j} as the total number of serving carrier measurement objects which are candidates to be measured in gap j where the measurement object i is also a candidate, otherwise M_{tot,i,j} equals 0. The carrier specific scaling factor CSSF_{within_gap,i} can be calculated by the formula CSSF_{within_gap,i}=max(ceil(Rᵢ×M_{tot,i,j})), where j=0 . . . (160/MGRP)−1, where Rᵢ is the maximal ratio of the number of measurement gap where measurement object i is a candidate to be measured over the number of measurement gap where measurement object i is a candidate and not used for a long-periodicity measurement defined above.

In some embodiments, at 402, UE 101 may determine whether the plurality of MOs 117 includes a MO different from an intra-frequency MO. If UE 101 determines there is no MO different from an intra-frequency MO, at 414, UE 101 may determine whether the first sharing parameter 116 indicates an equal sharing for the measurement gaps 119. If the first sharing parameter 116 indicates an equal sharing for the measurement gaps 119, at 416, UE 101 may determine the CSSF for each MO based on the number of serving carrier MOs that are candidates to be measured in a measurement gap. Additionally and alternatively, if the first sharing parameter 116 indicates an unequal sharing for the measurement gaps, at 426, UE 101 may detect whether there is the second sharing parameter 118 to indicate how to share the measurement gaps. At 428, UE 101 can detect what kind of parameter is the second sharing parameter 118, and further determine, at 429, a CSSF for a MO based on the second sharing parameter 118.

In some embodiments, the second sharing parameter 118 includes a parameter 441 based on MCG/SCG (cell group classification). In some embodiments, the second sharing parameter 118 includes a parameter 443 based on SPCC or SCC (component carrier classification). In some embodiments, the second sharing parameter 118 includes a parameter 445 based on frequency range classification. In some embodiments, the second sharing parameter 118 includes a parameter 447 determining an intra-frequency sharing scheme.

In some embodiments, the second sharing parameter 118 can include parameter 441 indicating how to share the plurality of measurement gaps 119 among MOs in a master cell group (MCG) and a secondary cell group (SCG), defined by a parameter measGapSharingSchemeBtwCGs. In some embodiments, the second sharing parameter 118 can include parameter 443 indicating how to share the plurality of measurement gaps 119 among MOs for a special component carrier (SPCC) or a secondary component carrier (SCC) for a secondary cell, defined by a parameter measGapSharingSchemeBtwSpCellAndSCell. In some embodiments, the SPCC can include PCC for PCell and CC for primary secondary cell (PScell). In some embodiments, the second sharing parameter 118 can include parameter 445 indicating how to share the plurality of measurement gaps 119 among MOs for a first frequency range or a second frequency range, defined by a parameter measGapSharingSchemeBtwFRs. In some embodiments, the second sharing parameter 118 can include parameter 447 indicating how to share the plurality of measurement gaps 119 among MOs for intra-frequency MOs unequally, defined by a parameter measGapSharingSchemeBtwIntra.

In some embodiments, if the number of configured inter-frequency and inter-RAT measurement objects and NR positioning reference signal (PRS) measurements on all positioning frequency layers is zero, the plurality of MOs 117 does not include a MO different from an intra-frequency MO. Instead, any MO of the plurality of MOs 117 is an intra-frequency MO. In some embodiments, UE 101 can be configured with per UE measurement gaps. Accordingly, UE 101 can classify the plurality of MOs 117 into two different groups. MCG intra-frequency measurement objects belong to group A, and SCG intra-frequency measurement objects belong to group B. A parameter M_{groupA,i,j} denotes the number of MCG intra-frequency measurement objects M_{intra-FR1,i,j}, including both SSB and CSI-RS based, which are candidates to be measured in measurement gap j where the measurement object i is also a candidate. Otherwise M_{groupA,i,j} equals 0. A parameter M_{groupBi,j} denotes the number of SCG intra-frequency measurement objects M_{intra-FR2,i,j}, including both SSB and CSI-RS based, which are candidates to be measured in gap j where the measurement object i is also a candidate. Otherwise M_{groupB,i,j} equals 0. A parameter M_{tot,i,j} is defined as M_{tot,i,j}=M_{groupA,i,j}+M_{groupB,i,j} to denote the total number of group A and group B measurement objects which are candidates to be measured in gap j where the measurement object i is also a candidate. Otherwise M_{tot,i,j} equals 0.

Based on the defined parameters, the carrier specific scaling factor CSSFwithin gap, i can be determined based on the second sharing parameter 118, where the second sharing parameter 118 can include parameter 441 measGapSharingSchemeBtwCGs. If the first sharing parameter 116 measGapSharingScheme indicates an equal sharing for the measurement gaps 119, at 416, UE 101 may determine the CSSF for each MO based on the number of serving carrier MOs that are candidates to be measured in a measurement gap. Additionally and alternatively, if the first sharing parameter 116 indicates an unequal sharing for the measurement gaps, at 426 and 428 combined, UE 101 may detect the second sharing parameter 118 to be parameter 441 measGapSharingSchemeBtwCGs, and further determine, at 429, a CSSF for a MO based on the second sharing parameter 118.

In some embodiments, if parameter 441 measGapSharingSchemeBtwCGs indicates equal sharing, CSSF_{within_gap,i}=max(ceil(Rᵢ×M_{tot,i,j})), where j=0 . . . (160/MGRP)−1. Additionally and alternatively, if parameter 441 measGapSharingSchemeBtwCGs is not equal sharing and measurement object i is a group A measurement object, CSSF_{within_gap,i} is the maximum between ceil(Rᵢ×K_{MCG}×M_{groupA,i,j}) in gaps, where M_{groupB,i,j} is not 0, where j=0 . . . (160/MGRP)−1; or ceil(Rᵢ×M_{groupA,i,j}) in gaps where M_{groupB,i,j}=0, where j=0 . . . (160/MGRP)−1. Additionally and alternatively, if measurement object i is an group B measurement object, CSSF_{within_gap,i} is the maximum among ceil(Rᵢ×K_{SCG}×M_{groupBi,j}) in gaps, where M_{groupA,i,j} is not 0, where j=0 . . . (160/MGRP)−1; or ceil(Rᵢ×M_{groupB,i,j}) in gaps, where M_{groupA,i,j}=0, where j=0 . . . (160/MGRP)−1. Rᵢ is the maximal ratio of the number of measurement gap where measurement object i is a candidate to be measured over the number of measurement gap where measurement object i is a candidate and not used for a long-periodicity measurement defined above.

In some embodiments, if the number of configured inter-frequency and inter-RAT measurement objects and NR positioning reference signal (PRS) measurements on all positioning frequency layers is zero, the plurality of MOs 117 does not include a MO different from an intra-frequency MO. Instead, any MO of the plurality of MOs 117 is an intra-frequency MO. In some embodiments, UE 101 can be configured with per UE measurement gaps. Accordingly, UE 101 can classify the plurality of MOs 117 into two different groups. PCC and PSCC intra-frequency measurement objects belong to group A, and SCC intra-frequency measurement objects belong to group B. A parameter M_{groupA,i,j} denotes the number of PCC/PSCC intra-frequency measurement objects, and M_{intra-FR1,i,j}, including both SSB and CSI-RS based, which are candidates to be measured in gap j where the measurement object i is also a candidate. Otherwise M_{groupA,i,j} equals 0. A parameter M_{groupBi,j} denotes the number of SCC intra-frequency measurement objects M_{intra-FR2,i,j}, including both SSB and CSI-RS based, which are candidates to be measured in gap j where the measurement object i is also a candidate. Otherwise M_{groupB,i,j} equals 0. A parameter M_{tot,i,j} is defined as M_{tot,i,j}=M_{groupA,i,j}+M_{groupB,i,j} to denote the total number of group A and group B measurement objects which are candidates to be measured in gap j where the measurement object i is also a candidate. Otherwise M_{tot,i,j} equals 0.

Based on the defined parameters, the carrier specific scaling factor CSSF_{within_gap,i} can be determined by the second sharing parameter 118, where the second sharing parameter 118 can be parameter 443 measGapSharingSchemeBtwSpCellAndSCell (indicate UE can further share the MG among the PCC/PSCC and SCC MOs on top of legacy measGapSharingScheme). If measGapSharingSchemeBtwSpCellAndSCell is equal sharing, CSSF_{within_gap,i}=max(ceil(Rᵢ×M_{tot,i,j})), where j=0 . . . (160/MGRP)−1. Additionally and alternatively, if measGapSharingSchemeBtwSpCellAndSCell is not equal sharing and measurement object i is a group A measurement object, CSSF_{within_gap,i} is the maximum among ceil(Rᵢ×K_{SPCC}×M_{groupA,i,j}) in gaps, where M_{groupB,i,j} is not 0, where j=0 . . . (160/MGRP)−1; or ceil(Rᵢ×M_{groupA,i,j}) in gaps where M_{groupB,i,j}=0, where j=0 . . . (160/MGRP)−1. Additionally, if measurement object i is an group B measurement object, CSSFwithin gap, i is the maximum among ceil(Rᵢ×K_{SCC}×M_{groupBi,j}) in gaps where M_{groupA,i,j} is not 0, where j=0 . . . (160/MGRP)−1; or ceil(Rᵢ×M_{groupB,i,j}) in gaps where M_{groupA,i,j}=0, where j=0 . . . (160/MGRP)−1. Rᵢ is the maximal ratio of the number of measurement gap where measurement object i is a candidate to be measured over the number of measurement gap where measurement object i is a candidate and not used for a long-periodicity measurement defined above.

In some embodiments, if the number of configured inter-frequency and inter-RAT measurement objects and NR positioning reference signal (PRS) measurements on all positioning frequency layers is zero, the plurality of MOs 117 does not include a MO different from an intra-frequency MO. Instead, any MO of the plurality of MOs 117 is an intra-frequency MO. In some embodiments, UE 101 can be configured with per UE measurement gaps. Accordingly, UE 101 can classify the plurality of MOs 117 into two different groups. FR1 intra-frequency measurement objects belong to group A, and FR2 intra-frequency measurement objects belong to group B. A parameter M_{groupA,i,j} denotes the number of FR1 intra-frequency measurement objects M_{intra-FR1,i,j}, including both SSB and CSI-RS based, which are candidates to be measured in gap j where the measurement object i is also a candidate. Otherwise M_{groupA,i,j} equals 0. A parameter M_{groupBi,j} denotes the number of FR2 intra-frequency measurement objects M_{intra-FR2,i,j}, including both SSB and CSI-RS based, which are candidates to be measured in gap j where the measurement object i is also a candidate. Otherwise M_{groupB,i,j} equals 0. A parameter M_{tot,i,j} is defined as M_{tot,i,j}=M_{groupA,i,j}+M_{groupB,i,j} to denote the total number of group A and group B measurement objects which are candidates to be measured in gap j where the measurement object i is also a candidate. Otherwise M_{tot,i,j} equals 0.

Based on the defined parameters, the carrier specific scaling factor CSSF_{within_gap,i} can be determined by the second sharing parameter 118, where the second sharing parameter 118 can be parameter 445 measGapSharingSchemeBtwFRs (indicate UE can further share the MG among the FR1 and FR2 on top of legacy measGapSharingScheme). If measGapSharingSchemeBtwFRs is equal sharing, CSSF_{within_gap,i}=max(ceil(Rᵢ×M_{tot,i,j})), where j=0 . . . (160/MGRP)−1. Additionally and alternatively, if measGapSharingSchemeBtwFRs is not equal sharing and measurement object i is a group A measurement object, CSSF_{within_gap,i} is the maximum among ceil(Rᵢ×K_{FR1}×M_{groupA,i,j}) in gaps where M_{groupB,i,j} is not 0, where j=0 . . . (160/MGRP)−1; or ceil(Rᵢ×M_{groupA,i,j}) in gaps where M_{groupB,i,j}=0, where j=0 . . . (160/MGRP)−1. Additionally, if measurement object i is an group B measurement object, CSSF_{within_gap,i} is the maximum among ceil(Rᵢ×K_{FR2}×M_{groupBi,j}) in gaps where M_{groupA,i,j} is not 0, where j=0 . . . (160/MGRP)−1; or ceil(Rᵢ×M_{groupB,i,j}) in gaps where M_{groupA,i,j}=0, where j=0 . . . (160/MGRP)−1. Rᵢ is the maximal ratio of the number of measurement gap where measurement object i is a candidate to be measured over the number of measurement gap where measurement object i is a candidate and not used for a long-periodicity measurement defined above.

In some embodiments, if the number of configured inter-frequency and inter-RAT measurement objects and NR positioning reference signal (PRS) measurements on all positioning frequency layers is zero, the plurality of MOs 117 does not include a MO different from an intra-frequency MO. Instead, any MO of the plurality of MOs 117 is an intra-frequency MO. In some embodiments, UE 101 can be configured with per UE measurement gaps. The carrier specific scaling factor CSSF_{within_gap,i} can be determined by the second sharing parameter 118, where the second sharing parameter 118 can be parameter 447 measGapSharingSchemeBtwIntra (indicate UE can further share the MG among the intra-freq MO with MG on top of legacy measGapSharingScheme). If measGapSharingSchemeBtwIntra is equal sharing, CSSF_{within_gap,i}=max(ceil(Rᵢ×total_intra-freq_withMG)), where j=0 . . . (160/MGRP)−1. Additionally and alternatively, if measGapSharingSchemeBtwIntra is not equal sharing and PCC with MG occupy the 50% of the resource of MG, and PSCC with MG occupy the 25% of the resource of MG. If there is a FR2 SCC with neighbor cell measurement, this FR2 SCC occupy 12.5% of the resource of MG, and other SCCs occupy 12.5% of the resource of MG. If there is no FR 2 SCC with neighbor cell measurement, all SCCs occupy 25% of the resource of MG. The numbers such as 50%, 25%, 12.5% are provided as examples only, and may change with different implementations and applications.

In some embodiments, at 402, if UE 101 determines there is a MO different from an intra-frequency MO, at 424, UE 101 may determine whether a first sharing parameter indicates an equal sharing for the measurement gaps. If the first sharing parameter indicates an equal sharing for the measurement gaps, at 436, UE 101 can determine a CSSF for a MO based on a number of frequency layers having a measurement gap. Additionally and alternatively, if the first sharing parameter indicates a non-equal sharing for the measurement gaps, UE 101 can perform operations at 426. At 426, UE 101 may detect whether there is the second sharing parameter 118 to indicate how to share the measurement gaps. At 428, UE 101 can detect what kind of parameter is the second sharing parameter 118, and further determine, at 429, a CSSF for a MO based on the second sharing parameter 118.

In some embodiments, the first sharing parameter 116 can be the parameter measGapSharingScheme, and the second sharing parameter 118 can be parameter 441 measGapSharingSchemeBtwCGs. KMCG is the sharing factor for MCG MOs and KSCG is the sharing factor for SCG. K factor is indicated by network for all options. If there are also inter-frequency or inter-RAT MOs to be measured, UE 101 may apply the routines outlined above following the operations at 424 to operations at 436, or following the operations at 424 to operations at 426 through operations at 428 to operations at 429.

In some embodiments, if measGapSharingScheme is equal sharing, CSSF_{within_gap,i}=max(ceil(Rᵢ×total_frequency_layer_withMG)), where j=0 . . . (160/MGRP)−1. If measGapSharingScheme is not equal sharing, and measGapSharingSchemeBtwCGs is equal sharing: for intra-frequency CSSF_{within_gap,i}=max(ceil(Rᵢ×Kintra*total_intra_frequency_layer_withMG)), where j=0 . . . (160/MGRP)−1. If measGapSharingScheme is not equal sharing, and measGapSharingSchemeBtwCGs is not equal sharing, measurement object i is a group A measurement object, CSSF_{within_gap,i} is the maximum among ceil(Rᵢ×Kᵢₙₜᵣₐ×KMCG*M_{groupA,i,j}) in gaps where M_{groupB,i,j} is not 0, where j=0 . . . (160/MGRP)−1; or ceil(Rᵢ×Kᵢₙₜᵣₐ*M_{groupA,i,j}) in gaps where M_{groupB,i,j}=0, where j=0 . . . (160/MGRP)−1. For measurement object i is an group B measurement object, CSSF_{within_gap,i} is the maximum among ceil(Rᵢ×Kᵢₙₜᵣₐ×KSCG×M_{groupBi,j}) in gaps where M_{groupA,i,j}≠0, where j=0 . . . (160/MGRP)−1; or ceil(Rᵢ×Kᵢₙₜᵣₐ×M_{groupB,i,j}) in gaps where M_{groupA,i,j}=0, where j=0 . . . (160/MGRP)−1.

In some embodiments, the first sharing parameter 116 can be the parameter measGapSharingScheme, and the second sharing parameter 118 can be parameter 443 measGapSharingSchemeBtwSpCellAndSCell. KSPCC is the sharing factor for PCC and PSCC; MOs and KSCC is the sharing factor for SCC. If there are also inter-frequency or inter-RAT MOs to be measured, UE 101 may apply the routines outlined above following the operations at 424 to operations at 436, or following the operations at 424 to operations at 426 through operations at 428 to operations at 429.

In some embodiments, if measGapSharingScheme is equal sharing, CSSF_{within_gap,i}=max(ceil(Rᵢ×total_frequency_layer_withMG)), where j=0 . . . (160/MGRP)−1.

If measGapSharingScheme is not equal sharing, and measGapSharingSchemeBtwSpCellAndSCell is equal sharing: for intra-frequency CSSF_{within_gap,i}=max(ceil(Rᵢ×Kintra*total_intra_frequency_layer_withMG)), where j=0 . . . (160/MGRP)−1.
If measGapSharingScheme is not equal sharing, and measGapSharingSchemeBtwSpCellAndSCell is not equal sharing:
measurement object i is a group A measurement object, CSSF_{within_gap,i} is the maximum among
   ceil(Rᵢ×Kᵢₙₜᵣₐ×KSPCC*M_{groupA,i,j}) in gaps where M_{groupB,i,j}≠0, where j=0 . . . (160/MGRP)−1
   ceil(Rᵢ×Kᵢₙₜᵣₐ*M_{groupA,i,j}) in gaps where M_{groupB,i,j}=0, where j=0 . . . (160/MGRP)−1
measurement object i is an group B measurement object, CSSF_{within_gap,i} is the maximum among
   ceil(Rᵢ×Kᵢₙₜᵣₐ×KSCC×M_{groupBi,j}) in gaps where M_{groupA,i,j}≠0, where j=0 . . . (160/MGRP)−1
   ceil(Rᵢ×Kᵢₙₜᵣₐ×M_{groupB,i,j}) in gaps where M_{groupA,i,j}=0, where j=0 . . . (160/MGRP)−1

In some embodiments, the first sharing parameter 116 can be the parameter measGapSharingScheme, and the second sharing parameter 118 can be parameter 445 measGapSharingSchemeBtwFRs. KFR1 is the sharing factor for FR1 serving carrier MOs and KSCC is the sharing factor for FR2 serving carrier. If there are also inter-frequency or inter-RAT MOs to be measured, UE 101 may apply the routines outlined above following the operations at 424 to operations at 436, or following the operations at 424 to operations at 426 through operations at 428 to operations at 429.

In some embodiments, if measGapSharingScheme is equal sharing, CSSF_{within_gap,i}=max(ceil(Rᵢ×total_frequency_layer_withMG)), where j=0 . . . (160/MGRP)−1.

If measGapSharingScheme is not equal sharing, and measGapSharingSchemeBtwFRs is equal sharing: for intra-frequency CSSF_{within_gap,i}=max(ceil(Rᵢ×Kintra*total_intra_frequency_layer_withMG)), where j=0 . . . (160/MGRP)−1.
If measGapSharingScheme is not equal sharing, and measGapSharingSchemeBtwFRs is not equal sharing:
measurement object i is a group A measurement object, CSSF_{within_gap,i} is the maximum among
   ceil(Rᵢ×Kᵢₙₜᵣₐ×KFR1*M_{groupA,i,j}) in gaps where M_{groupB,i,j}≠0, where j=0 . . . (160/MGRP)−1
   ceil(Rᵢ×Kᵢₙₜᵣₐ*M_{groupA,i,j}) in gaps where M_{groupB,i,j}=0, where j=0 . . . (160/MGRP)−1
measurement object i is an group B measurement object, CSSF_{within_gap,i} is the maximum among
   ceil(Rᵢ×Kᵢₙₜᵣₐ×KFR2×M_{groupBi,j}) in gaps where M_{groupA,i,j}≠0, where j=0 . . . (160/MGRP)−1
   ceil(Rᵢ×Kᵢₙₜᵣₐ×M_{groupB,i,j}) in gaps where M_{groupA,i,j}=0, where j=0 . . . (160/MGRP)-1

In some embodiments, the first sharing parameter 116 can be the parameter measGapSharingScheme, and the second sharing parameter 118 can be parameter 447 measGapSharingSchemeBtwIntra. KFR1 is the sharing factor for FR1 serving carrier MOs and KSCC is the sharing factor for FR2 serving carrier. If there are also inter-frequency or inter-RAT MOs to be measured, UE 101 may apply the routines outlined above following the operations at 424 to operations at 436, or following the operations at 424 to operations at 426 through operations at 428 to operations at 429.

In some embodiments, if measGapSharingScheme is equal sharing, CSSF_{within_gap,i}=max(ceil(Rᵢ×total_frequency_layer_withMG)), where j=0 . . . (160/MGRP)−1. If measGapSharingScheme is not equal sharing, and measGapSharingSchemeBtwIntra is equal sharing: for intra-frequency CSSF_{within_gap,i}=max(ceil(Rᵢ×Kintra*total_intra_frequency_layer_withMG)), where j=0 . . . (160/MGRP)−1.

If measGapSharingScheme is not equal sharing, and measGapSharingSchemeBtwIntra is not equal sharing:
CSSF_{within_gap_i} for PCC is ceil(Rᵢ×Kᵢₙₜᵣₐ×(1/50%)) in gaps;
CSSF_{within_gap_i} for PSCC is ceil(Rᵢ×Kᵢₙₜᵣₐ×(1/25%)) in gaps;
   If there is a FR2 SCC with neighbor cell measurement, CSSF_{within_gap_i} for FR2 SCC with neighbor cell measurement is ceil(Rᵢ×Kᵢₙₜᵣₐ×(1/12.5%)) in gaps and CSSF_{within_gap_i} for other SCCs is ceil(Rᵢ×Kᵢₙₜᵣₐ×(1/12.5%)*SCC_layers). If there is no FR2 SCC with neighbor cell measurement, CSSF_{within_gap_i} for all SCCs is ceil(Rᵢ×Kᵢₙₜᵣₐ×(1/12.5%)*SCC_layers).

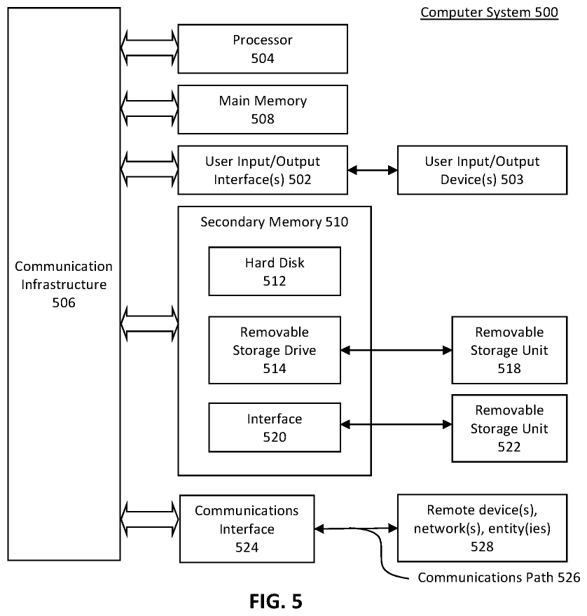

Various aspects can be implemented, for example, using one or more computer systems, such as computer system 500 shown in FIG. 5. Computer system 500 can be any computer capable of performing the functions described herein such as UE 101, or base station 103 as shown in FIG. 1 and FIG. 2, for operations described for UE 101 or process 300 and process 400 as shown in FIGS. 3 and 4. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 508, the removable storage unit 518, the removable storage unit 522 can store instructions that, when executed by processor 504, cause processor 504 to perform operations for a UE or a base station, e.g., UE 101, or base station 103 as shown in FIG. 1 and FIG. 2, for operations described for UE 101 or process 300 and process 400 as shown in FIGS. 3 and 4.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526. Operations of the communication interface 524 can be performed by a wireless controller, and/or a cellular controller. The cellular controller can be a separate controller to manage communications according to a different wireless communication technology. The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

For one or more embodiments or examples, at least one of the components set forth in one or more of the preceding figures may be configured to perform one or more operations, techniques, processes, and/or methods as set forth in the example section below. For example, circuitry associated with a thread device, routers, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

1. A user equipment (UE), comprising:
a transceiver configured to enable wireless communication in a wireless system supporting dual connectivity having a plurality of base stations in a plurality of cells utilizing a corresponding plurality of component carriers, the plurality of base stations including a first base station in a primary cell (PCell) utilizing a primary component carrier (PCC) in a first frequency band and a second base station in a primary secondary cell (PSCell) utilizing a primary secondary component carrier (PSCC) in a second frequency band; and
a processor communicatively coupled to the transceiver and configured to:
receive a measurement object (MO) configuration to configure a plurality of MOs corresponding to the plurality of cells utilizing the corresponding plurality of component carriers including the PCC and PSCC;
determine a measurement gap configuration to configure a plurality of measurement gaps shared by the plurality of MOs;
determine a measurement gap sharing scheme based at least on whether the plurality of MOs includes any MO different from an intra-frequency MO, wherein the measurement gap sharing scheme indicates how to share the plurality of measurement gaps to perform measurements on the plurality of MOs;
determine a carrier specific scaling factor (CSSF) for a MO of the plurality of MOs based on the measurement gap sharing scheme;
determine, based on the CSSF for the MO, a measurement period corresponding to the MO to perform a measurement on the MO within the plurality of measurement gaps; and
perform, or cause to perform, the measurement on the MO within the plurality of measurement gaps during the measurement period.

2. The UE of claim 1, wherein the first frequency band is in a first frequency range, and the second frequency band is in the first frequency range or a second frequency range.

3. The UE of claim 1, wherein the dual connectivity supported by the wireless system includes a new radio (NR) dual connectivity (DC).

4. The UE of claim 1, wherein the MO includes a synchronization signal block (SSB), or a channel state information reference signal (CSI-RS).

5. The UE of claim 1, wherein to determine the measurement gap sharing scheme, the processor is further configured to:
in response to a determination that the plurality of MOs include only intra-frequency MOs, apply a first measurement gap sharing scheme;
in response to a determination that the plurality of MOs includes a MO that is not an intra-frequency MO, apply a second measurement gap sharing scheme different from the first measurement gap sharing scheme.

6. The UE of claim 1, wherein to determine the measurement gap sharing scheme, the processor is further configured:
in response to a determination that the plurality of MOs include only intra-frequency MOs, apply a measurement gap sharing scheme indicating to share the plurality of measurement gaps equally among a plurality of MOs over a plurality of serving cells including the PCell and PSCell, and
wherein to determine the CSSF for the MO of the plurality of MOs over the plurality of serving cells includes to determine the CSSF based on a total number of measurement objects over the plurality of serving cells for the plurality of measurement gaps.

7. The UE of claim 1, wherein to determine the measurement gap sharing scheme, the processor is further configured to determine that the plurality of MOs includes at least a MO that is not an intra-frequency MO, and that a first sharing parameter indicates to share the plurality of measurement gaps equally, and
wherein to determine the CSSF for the MO of the plurality of MOs over the plurality of serving cells, the processor is further configured to determine the CSSF based on a total number of frequency layers having the measurement gap configuration.

8. The UE of claim 1, wherein to determine the measurement gap sharing scheme, the processor is further configured to determine that a first sharing parameter indicates to share the plurality of measurement gaps unequally, and further to determine the measurement gap sharing scheme based on a second sharing parameter.

9. The UE of claim 8, wherein the second sharing parameter includes a parameter indicating how to share the plurality of measurement gaps among MOs in a master cell group and a secondary cell group.

10. The UE of claim 8, wherein the second sharing parameter includes a parameter indicating how to share the plurality of measurement gaps among MOs for a special component carrier (SPCC) or a secondary component carrier (SCC).

11. The UE of claim 8, wherein the second sharing parameter includes a parameter indicating how to share the plurality of measurement gaps among MOs for a first frequency range or a second frequency range.

12. The UE of claim 8, wherein the second sharing parameter includes a parameter indicating how to share the plurality of measurement gaps among MOs for intra-frequency MOs unequally.

13. A method for a user equipment (UE), comprising:
receiving, by the UE, a measurement object (MO) configuration to configure a plurality of MOs corresponding to a plurality of cells utilizing a corresponding plurality of component carriers, wherein the UE is configured to communicate in a wireless system supporting a dual connectivity having a plurality of base stations in the plurality of cells utilizing the corresponding plurality of component carriers, the plurality of base stations including a first base station in a primary cell (PCell) utilizing a primary component carrier (PCC) in a first frequency band and a second base station in a primary secondary cell (PSCell) utilizing a primary secondary component carrier (PSCC) in a second frequency band;
determining a measurement gap configuration to configure a plurality of measurement gaps shared by the plurality of MOs;
determining a measurement gap sharing scheme based at least on whether the plurality of MOs includes any MO different from an intra-frequency MO, wherein the measurement gap sharing scheme indicates how to share the plurality of measurement gaps to perform measurements on the plurality of MOs;
determining a carrier specific scaling factor (CSSF) for a MO of the plurality of MOs based on the measurement gap sharing scheme;
determining, based on the CSSF for the MO, a measurement period corresponding to the MO to perform measurement on the MO within the plurality of measurement gaps; and
performing, or causing to perform, the measurement on the MO within the plurality of measurement gaps during the measurement period.

14. The method of claim 13, wherein the first frequency band is in a first frequency range, and the second frequency band is in the first frequency range or a second frequency range.

15. The method of claim 13, wherein the dual connectivity supported by the wireless system includes a new radio (NR) dual connectivity (DC).

16. The method of claim 13, wherein the MO includes a synchronization signal block (SSB), or a channel state information reference signal (CSI-RS).

17. The method of claim 13, wherein the determining the measurement gap sharing scheme includes:
in response to the plurality of MOs including only intra-frequency MOs, determining to apply a first measurement gap sharing scheme;
in response to the plurality of MOs including a MO that is not an intra-frequency MO, determining to apply a second measurement gap sharing scheme different from the first measurement gap sharing scheme.

18. The method of claim 13, wherein the determining the measurement gap sharing scheme includes determining that a first sharing parameter indicates to share the plurality of measurement gaps unequally, and further determining the measurement gap sharing scheme based on a second sharing parameter.

19. A non-transitory computer-readable medium storing instructions that, when executed by a processor of a user equipment (UE), cause the UE to perform operations, the operations comprising:
receiving, by the UE, a measurement object (MO) configuration to configure a plurality of MOs corresponding to a plurality of cells utilizing a corresponding plurality of component carriers, wherein the UE is configured to communicate in a wireless system supporting a dual connectivity having a plurality of base stations in the plurality of cells utilizing the corresponding plurality of component carriers, the plurality of base stations including a first base station in a primary cell (PCell) utilizing a primary component carrier (PCC) in a first frequency band and a second base station in a primary secondary cell (PSCell) utilizing a primary secondary component carrier (PSCC) in a second frequency band;
determining a measurement gap configuration to configure a plurality of measurement gaps shared by the plurality of MOs;
determining a measurement gap sharing scheme based at least on whether the plurality of MOs includes any MO different from an intra-frequency MO, wherein the measurement gap sharing scheme indicates how to share the plurality of measurement gaps to perform measurements on the plurality of MOs;
determining a carrier specific scaling factor (CSSF) for a MO of the plurality of MOs based on the measurement gap sharing scheme;
determining, based on the CSSF for the MO, a measurement period corresponding to the MO to perform measurement on the MO within the plurality of measurement gaps; and
performing, or causing to perform, the measurement on the MO within the plurality of measurement gaps during the measurement period.

20. The non-transitory computer-readable medium of claim 19, wherein the first frequency band is in a first frequency range, and the second frequency band is in the first frequency range or a second frequency range;
wherein the dual connectivity supported by the wireless system includes a new radio (NR) dual connectivity (DC); and
wherein the MO includes a synchronization signal block (SSB), or a channel state information reference signal (CSI-RS).
